(19) United States
(12) Patent Application Publication
(10) Pub. No.: US 2010/0220613 A1
(43) Pub. Date: Sep. 2, 2010

(54) NETWORK NODE OPTIMIZATION WITH TRIGGERED EXPRESSIONS

(76) Inventors: Jozef Henricus Petrus Hendriks, Tilburg (NL); Erik Jan Reitsma, Zoetermeer (NL); Hugo Zwaal, Breda (NL); Mieke Verheijen, Berchem (Antwerpen) (BE)

Correspondence Address: ERICSSON INC., 6300 LEGACY DRIVE, M/S EVR 1-C-11, PLANO, TX, 75024, US

(21) Appl. No.: 12/439,990

(22) PCT Filed: Sep. 5, 2006
(86) PCT No.: PCT/NL06/50221

§ 371 Date: May 6, 2010

(51) Int. Cl. H04L 12/26

(52) U.S. Cl. 370/252

(57) ABSTRACT

Method for providing a service in a communication network (1), and service node (10) arranged to execute that service. The service node (10) is arranged to receive and evaluate a request from the service, the request comprising an expression having multiple elements. Each element relates to data originating from one or more context sources (B, D, E), which can provide the data to the service node (10), e.g. using context source proxies (B′, D′, E′). Each context source (B, D, E) updates its associate data using a request based mechanism or an event trigger based mechanism. One of the plurality of elements is selected, and if the selected element evaluates to false, the selected element is switched to a trigger mode. If the selected element evaluates to true, then a further element is interrogated.

### TECHNICAL FIELD

The present invention relates to a method for providing a service in a communication network, in which the service comprises evaluating a request comprising an expression, the expression being a function (e.g. a boolean function) of a plurality of elements, each element relating to data originating from one or more context sources available in the communication network. In a further aspect, the present invention relates to a service node for a communication network.

### BACKGROUND

Currently when a context source provides information to a requestor in a communication network, this is either done by event trigger based or request based mechanisms. Some service require the evaluation of an expression of the values of one or more context sources. For each evaluation the context sources are interrogated. This may cause an unacceptable amount of communication between the service node and the context source or context sources.

### SUMMARY

The present invention seeks to provide an improvement in network performance for a communication network providing a service involving multiple context sources.

According to the present invention, a method according to the preamble defined above is provided, in which each one of the one or more context sources updates its associated data using a request based mechanism or an event trigger based mechanism, the method comprising interrogating a selected one of the plurality of elements, if the selected element evaluates to false, then switching the selected element to a trigger mode, and if the selected element evaluates to true, then proceeding with interrogating a further one of the plurality of elements. In this manner, the network resources may be used much more efficiently, by only further evaluating an expression when one of the elements of the expression is evaluated as true.

In a further embodiment, the method further comprises determining an order of context sources based on the expression and weights of the context sources, a weight of a context source being a function of network resources used and a monetary value for evaluation of the expression towards the one or more context sources, and in which the selected element is the lowest order context source, and the further one of the plurality of elements is the next lowest order context source. By first dealing with the lowest weight context source, the evaluation of an expression is performed at the lowest overall cost.

In a further embodiment the expression is a boolean function, the data from each of the context sources being true or false. This allows a quick evaluation of the expression by the service. In an alternative embodiment, the data from the context sources is a numeric value, and the expression comprises a function of the values of the context sources. This function e.g. comprises a comparison of the numeric value with a predetermined range (is value of source E between 2 and 6, larger than 4, etc.). This allows easier interfacing with the context sources, as context sources may already be present or available in the network, but only provide numerical values.

The function may in a further embodiment comprise an evaluation of a mathematic operation of the values of one or more of the context sources. The mathematic operation may be a simple addition, but also more complex mathematical functions are allowable. The evaluation of a mathematical operation involving data values from two or more context sources may involve setting a trigger threshold, depending on the actual values and the mathematical operation.

The data from each of the context sources may in a further embodiment also have the value unknown. The method may further be arranged to deal with a value of unknown returned by a context source, e.g. depending on the kind of expression which is evaluated (e.g. a boolean AND or OR function). In an even further embodiment, the method further comprises to use a latest obtained value for the respective context source value if the value is unknown. In both embodiments, efficiency related to the service (e.g. the use of network resources and monetary cost) is further improved.

The data of each the plurality of context sources is in a further embodiment stored in an associated proxy server, which is directly accessible for the service. Use of a proxy server or proxy may facilitate the possibilities of making data available to applications in the network, and provide a quicker access to these data.

In an even further embodiment, a child expression is used by multiple parent expressions, and the weight for evaluating the child expression is shared between the multiple parent expressions when the associated requests are received simultaneously. This provides a further opportunity to improve the efficiency for the service in the network.

In a further aspect, the present invention relates to a service node for a communication network providing a service in the communication network, in which the service node is arranged to receive and evaluate a request, the request comprising an expression being a function of plurality of elements, each element relating to data originating from one or more context sources, the service node, in operation, being connectable to the one or more context sources, in which the service node is further arranged to execute the method according to any embodiment of the present invention. For that, the service node may further comprise a rule interpreter for evaluating the expression. Also, the service node may further comprise a context information collector for interfacing with the one or more context sources. The context information collector may in an even further embodiment comprise a context source proxy for each of the one or more context sources, for storing data associated with each respective context source. When the context source operates according to the request based mechanism, the context source receives requests for its value from the service node and will reply to the service node with the current value. When the context source operates according to the trigger based mechanism, the context source receives a request for an event from the service node. Each time the value of the context source changes, the context source will send an event with the current value to the service node. The service node (or associated context source proxy) stores the latest received value from the context and any requests from the service for the value of the context source will not cause a request to the context source, but instead the stored latest value will be provided to the service.

With the optimizations described in this invention together the required resources for a service depending on different context sources will be reduced to the minimum without loosing the required performance in terms of latency and cost.

### BRIEF DESCRIPTION OF THE DRAWINGS

The present invention will be discussed in more detail below, using a number of exemplary embodiments, with reference to the attached drawings, in which

FIG. 1 shows a schematic diagram of a network allowing the evaluation of an expression;

FIG. 2 shows a schematic diagram of a network implementing an embodiment of the present invention;

FIG. 3 shows a schematic diagram of a network, in which the evaluation of an expression is performed according to an embodiment of the present invention;

FIG. 4 shows a sequence diagram of a naïve implementation of an evaluation of an expression;

FIG. 5 shows a sequence diagram of an implementation of an evaluation of an expression according to an embodiment of the present invention;

FIG. 6 shows a sequence diagram of an implementation of an evaluation of an expression according to a further embodiment of the present invention;

FIG. 7 shows a sequence diagram of an implementation of an evaluation of an expression according to a further embodiment of the present invention;

FIG. 8 shows a schematic diagram of a network, in which an expression is shared by multiple parent expressions;

FIG. 9 shows a sequence diagram of an implementation of an evaluation of an expression according to a further embodiment of the present invention; and

FIG. 10 shows a sequence diagram of an implementation of an evaluation of an expression according to a further embodiment of the present invention in which sharing is applied; and

FIG. 11 shows a schematic diagram of a further possible scenario in a communication network using an embodiment of the present invention.

### DETAILED DESCRIPTION

The present invention may be applied and implemented in any type of communication network structure, such as a cellular telecommunication network. The various method embodiments described below may be implemented in one of existing network hardware components or in a separate service node which interfaces with other nodes and/or components in the network 1 as required.

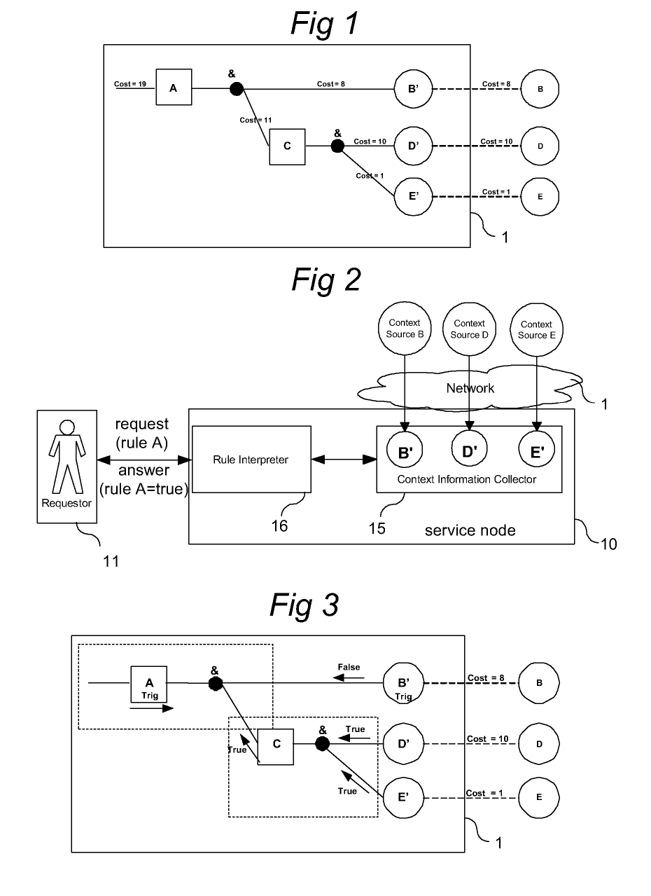

The basic concept of the present invention is illustrated in the network structure representation shown in FIG. 1. Only the elements needed to understand the invention are shown here. A service or application may use a network 1 to obtain the evaluation of an expression A depending on a plurality of elements. Actual context sources B, D, and E (providing data related to context information) may be located outside of the network 1, but are able to communicate with the network 1. E.g., the network 1 may comprise context source proxies (or context source proxy servers) B′, D′, and E′, providing context source information in the network 1.

The network 1 shown in FIG. 1 may represent any kind of service depending on data from context sources B, D and E with certain relations or expressions A and C between them. A request from an application or service depends on the evaluation of an expression A. In the situation shown in FIG. 1, the expression A depends on two elements, i.e. another expression C (intermediate expression) and the value of context source B. The expression C depends on the value of context sources D, E as illustrated in FIG. 1.

Other expressions may also be used in the embodiments of the present invention. Although the expression A illustrated above comprises one further expression (expression C), it is also envisageable that no intermediate expressions are present, i.e.

the expression A to be evaluated depends directly on information (data) from one or more context sources B, D, E. Also, more complex expressions may be necessary when implementing certain network services, e.g. comprising multiple intermediate expressions.

A possible implementation of the present invention in a telecommunication network is shown in FIG. 2. Again, the context sources B, D and E are shown as being positioned outside the network 1. A requestor 11 (e.g. an application being executed in a mobile telephone operated by a user) may send a request to a service node 10, which service node 10 may be part of the network 1, or, as indicated in FIG. 2, is connected to the network 1. The service node 10 comprises a context information collector 15 connected to the context sources B, D, E, through the network 1, and a rule interpreter 16 connected to the context information collector 15 and the requestor 11. The network 1 forms the transport facility of information coming from the physical context sources B, D, E. The physical context sources are positioned outside the service node 10, but are represented within the service node 10 by their respective proxies B′, D′, E′. The functionalities indicated in FIG. 2 may be implemented as software programs loaded on a processing device which is known as such, e.g. in the form of the service node 10, or another already existing processing device in the network 1. The context source proxies B′, D′ and E′ may be implemented as part of the context information collector 15. A request (indicated by Request(Rule A) in FIG. 2) is posted at the rule interpreter 16 by the requestor 11. In this case, the request concerns the evaluation of an expression Rule A, which is, as shown in relation to FIG. 1, based on the three context sources B, D and E. The relation between rules and context sources is already outlined in relation to FIG. 1 above. The requestor 11 is notified by the rule interpreter 16 when rule A evaluates to true. In order to have an as accurate as possible context information the context source proxies B′, D′, E′ may be updated with an event triggering based mechanism, a request based mechanism, or a combination of both. Furthermore, the proxies may be programmed to update the information at regular intervals.

In order to have an as accurate as possible context information the context sources B, D, E will update the requestor 11 with a combination of event trigger based and request based mechanisms. This means that the context source B, D, E, or the context source proxy B′, D′, E′ can adapt its update mechanism to the current needs.

According to an embodiment of the present invention, the mechanism used may be updated based on one or more of the following parameters or criteria, which may be available from or in the network 1:
Frequency of occurrence of a request towards a selected context source;
Frequency of occurrence of an event associated with a selected context source;
Cost or weight of a request (i.e., a function of network resources used and a monetary value for interrogating a context source);
Cost or weight of an event (i.e., a function of network resources used and a monetary value for dealing with an event from a context source);
Relation to other context sources and whether the value is actually needed by the requestor.

The value of a context source B, D, E can be rather volatile or not. This depends heavily on the type of context source B, D, E. For instance, a calendar context source (e.g., indicating whether a person is in-meeting or not) for a person might change at the most about every hour, whereas the person's location might change every second while travelling.

The cost of a request illustrates what the actual cost is of a single value request for a particular context source B, D, E. This can be the cost for the requestor 11 in FIG. 2, or the cost for the service node 10 (more specifically the rule interpreter 16). The cost is represented by a weight value determined in terms of network resources (=N) and money=( [symbol] ): weight=f(N, [symbol] )

The actual overall cost of a request (first cost value) for the present method embodiment is represented by the following:

Cost_{request}=Frequency_{request}*weight_{request}

in which Frequency_{request} is the frequency of occurrence of the request, and weight_{request} is the above defined cost of a single value request for the selected context source B, D, E. The frequency of occurrence of the request may be derived from historical data, but may also be determined as an estimate or a projected value for the future.

The actual overall cost of an event (e.g. a change of value of a context source), or a second cost value, for the present method embodiment is represented by the following:

Costₑᵥₑₙₜ=Cost_{triggering}+(Frequencyₑᵥₑₙₜ*weightₑᵥₑₙₜ)

in which Frequencyₑᵥₑₙₜ is the frequency of occurrence of the event, and weightₑᵥₑₙₜ is the above defined cost of a single event for the selected context source B, D, E. Cost_{triggering} is the additional cost involved with the event trigger based mechanism. Again, the frequency of occurrence of the event may be derived from historical data, but may also be determined as an estimate or a projected value for the future.

In an alternative embodiment, the factor Cost_{triggering} is neglected when determining the actual overall cost of an event.

By default triggering is turned off for each context source proxy B′, D′, E′ in order not to consume any resources (i.e., money and network resources) before an actual request comes in (i.e. all are using a request based mechanism for updating).

The context source proxy B′, D′, E′ will decide to turn into triggering mode when the first cost value (Cost_{request}) is (Cost larger than a first switching value, e.g. the second cost value (Costₑᵥₑₙₜ).

When the context source proxy B′, D′, E′ is in triggering mode and is triggered due to a value change, and the context source proxy did not have a pending request, the context source proxy will decide to turn off triggering when the second cost value (Costₑᵥₑₙₜ) is larger than a second switching value, e.g. the first cost value (Cost_{request}).

This way the context source update mechanism is adapted to the fact whether it is more expensive to trigger for an event and/or wait for an actual request.

In the above, the context source proxies B′, D′, E′ are arranged to evaluate the cost comparison, e.g. as a functionality of the context information collector 15 of the service node 10 (see FIG. 2). However, this functionality may also be provided in other parts of the system able to communicate with the context sources B, D, E, such as the context sources B, D, E, themselves, the rule interpreter 16, or the requestor 11.

Furthermore, the cost values are calculated on the basis of historical information in the above described embodiment. However, other related data may also be used, such as estimated data or projected (future) data. Also, the cost evaluation may be based on the frequency of occurrence of requests and events only, i.e. the switch between trigger mode and request mode occurs based on evaluation of the frequency of occurrence only.

A hysteresis mechanism will prevent a ‘flickering-effect’ (continuous toggling between request and trigger mode) when the Cost_{event is more or less the same as}

Cost_{request}. This can easily be implemented by adding a hysteresis delta value to the cost associated with the update mechanism not used, or by subtracting the hysteresis delta value from the cost associated with the actually used update mechanism. In the above embodiments, a hysteresis delta value may be added to the first switching value, the second switching value or both the first and second switching value.

On network level there are several possible optimization mechanisms. A first optimization mechanism is triggering based on boolean values. Any node (expression) in the network can start the triggering mechanism which will start triggering on the nodes behind it using the mechanism described above. In one embodiment, the first trigger will be set on the cheapest (lowest weight) context source proxy (E′). When context source proxy E′ becomes true, the next lowest weight context source proxy (context source proxy D′) will be set into triggering mode. When context source proxy D′ does not fire context source proxy E′ will be set into request mode again. When context source proxy D′ fires (value of D=true) the trigger is set on context source proxy E′ again. When context source proxy E′ fires (value of E=true), expression C will fire and a trigger is set on context source proxy B′. When context source proxy B′ is false the expression C will be set in request mode. This is will also be propagated to the context source proxies D′ and E′ as is shown in the schematic diagram of FIG. 3.

When the trigger on context source proxy B′ fires (value of B=true) the trigger is set again on expression C and propagated to the context source D′ and E′. When the values on context sources D and E are still true the trigger on the context source proxies D′ and E′ will fire and cause expression C to fire (=true). Eventually expression A will fire when context source A is still true.

From the above it is clear that switching to an event trigger based mechanism may be accomplished for any on of present context sources, but also for intermediate expressions (in the above examples, expression C).

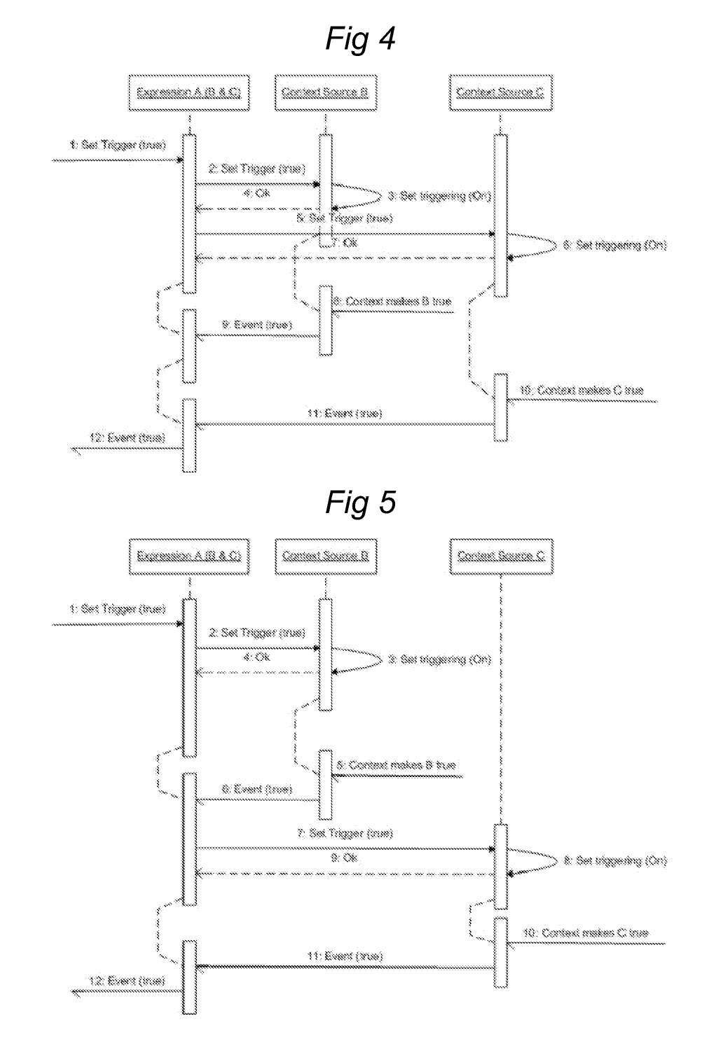

The above embodiment may also be described using sequence diagrams, which are shown in FIGS. 4, 5 and 6 for a number of embodiments according to the present invention. For these examples, the scenario situation of FIG. 1 (described above) is used, for the specific situation where triggering is set on expression A (indicated by 1: Set Trigger (true) in FIGS. 4, 5 and 6) while context source B and C have the value False. The Expression is as follows: A =B & C.

In a naïve implementation, which is shown schematically in FIG. 4 triggering for both context sources B and C will be set (indicated by the sequence 2-4 and 5-7 in FIG. 4) and the evaluation of expression A will waits until both context sources B and C are true. Only when the context of both context source B and expression C are true (indicated by sequences 8, 9 and 10, 11 in FIG. 4), the trigger mechanism for expression A will generate event 12, and expression A will be evaluated as true.

In a first optimized implementation according to an embodiment of the present invention, of which the sequence diagram is shown in FIG. 5. In this case, the trigger mechanism is only turned on for one context source (context source proxy B′, sequences 2, 3, 4 in FIG. 5) and waits for this context source proxy B′ to return the value true. When this happens (sequences 5-6 in FIG. 5), the next element of expression A (i.e. expression C) is switched to trigger mode (sequences 7-9 in FIG. 5) and only when this context source becomes true (sequence 10, 11 in FIG. 5), the trigger mechanism for expression A will generate event 12, and expression A will be evaluated as true.

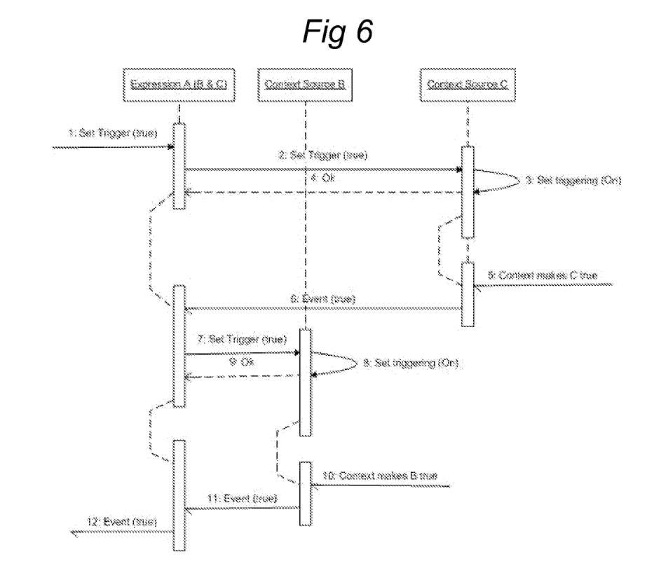

In a second optimized implementation according to a further embodiment of the present invention, of which the sequence diagram is shown in FIG. 6, the trigger mechanism is only turned on for the cheapest element of expression A (i.e. the element of expression A of which the weight for evaluation is the lowest). In this case, this is the intermediate expression C. As indicated in FIG. 6, triggering is activated for element C (sequences 2-4), and the evaluation further waits for this element source to return the value true (which is indicated by sequences 5-6 in FIG. 6). Only then, the next cheapest element of expression A (i.e. context source B) is switched to an event based trigger mechanism (sequences 7-9). When this context source B generates an event as the value thereof changes to true (sequence 10 in FIG. 6), this is relayed to the evaluation of expression A (event of context source B, sequence 11), which then generates an event that the expression A has evaluated as true (sequence 12 in FIG. 6).

In a second set of embodiments of the present invention, the optimization mechanism is using an event trigger based mechanism, in which trigger threshold values are based on value ranges, e.g. integer value ranges. This optimization considers the fact that the actual value of context sources B, D, E, is only of interest to the requestor 11 within certain value ranges and will therefore influence the triggering frequency. As a result, the number of events generated by the respective context source B, D, E is minimized, thus improving efficiency of use of the network and other resources.

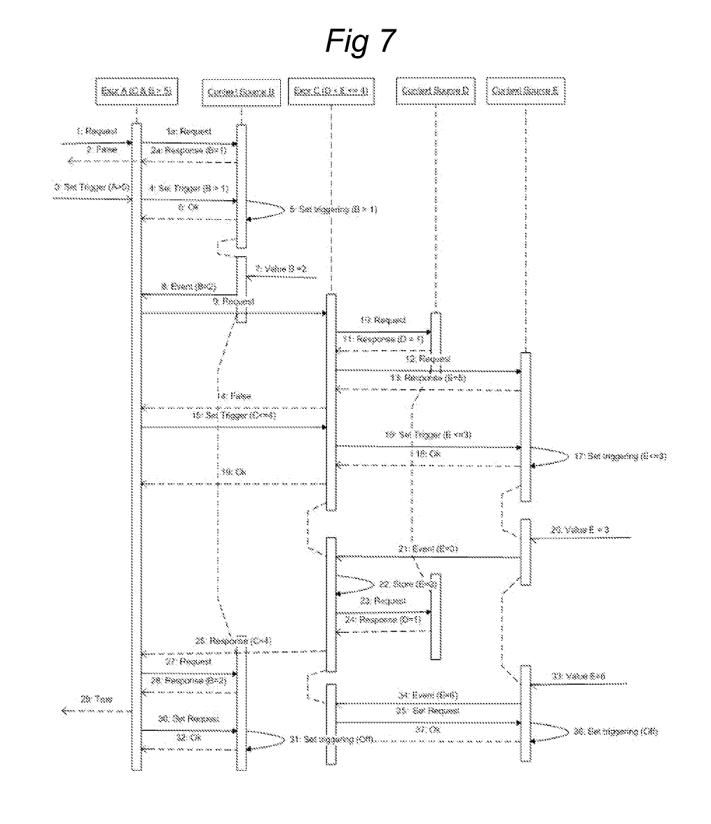

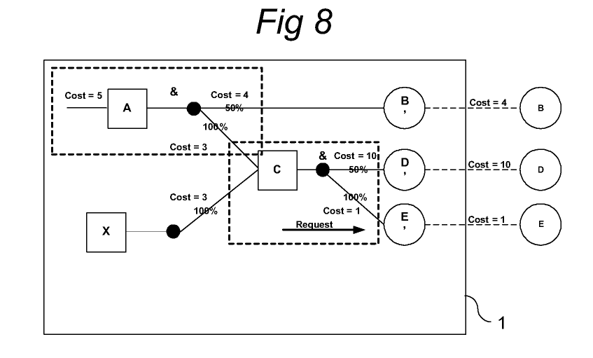

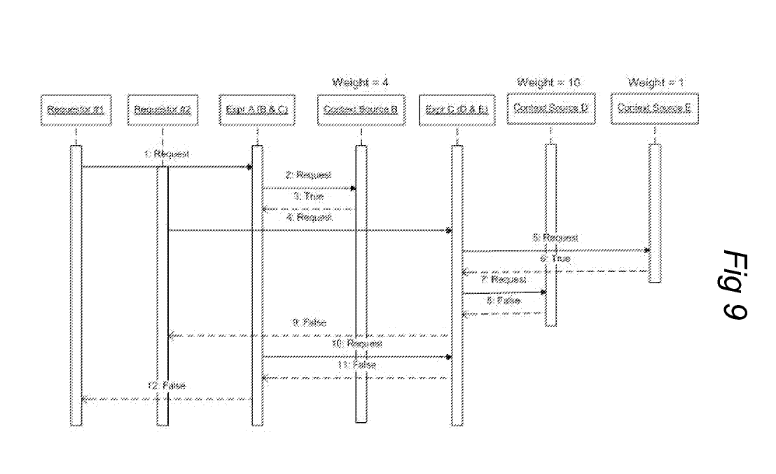

The sequence diagram of FIG. 7 shows an example of this scenario in more detail:

Step 1-6:
A request comes in for Expression A. Context source B is requested for its value and returns 1. A trigger (on true) is set for Expression A and therefore a trigger (B>1) is set for context source B.

Step 7-9:
Context source B becomes higher then 1 (B=2) generating an event (7) from context source B, and subsequently a request (9) is sent to Expression C.

Step 10-14:
The incoming request for Expression C causes Expression C to request the values of context sources D (=1) and E (=5). Expression C evaluates false and sends a response False to Expression A.

Step 15-19:
A trigger (on true) is set for expression C and therefore a trigger (E<=3) is set for context source E, because context source E is less expensive then context source D (see previously described embodiments).

Step 20-26:
Context source E becomes 3 and an event (21) is sent to Expression C. Expression C requests the value (D=1) of context source D and Expression C evaluates true (C=4) and sends a response (=true) to Expression A.

Step 27-29:
Expression A requests the value (B=2) of context source B and Expression A evaluates true and sends a True event (29) to the requestor 11.

Step 30-32:
Context source B is set into request mode on request of Expression A.

Step 33-37:
Context source E gets an event because of a value change and sends an event to Expression C. Since there is no request for Expression C it will set the context source E back into request mode.

As indicated in the above example, the trigger thresholds may be set by the requesting node (expression A or C) depending on the current circumstances.

In a further example, C is again a function of context sources D and E, and the following expressions may be evaluated: A=(C>10), C=D+E. In this case, expression A evaluates to true when the sum of values of context source D and E is above a certain constant value (C>10). Initially both context source D and E are evaluated to calculate the value of expression C. Then it can be determined what value transitions could cause expression C to evaluate true, and the resulting condition is split over context sources D and E. This means that a request for the actual value (=d) of context source D is done. Only when the value of context source D will make

Expression C to return a value<10, context source E is requested for its actual value (=e). The trigger thresholds on context sources D and E (or context source proxies D′ and E′) will be equally divided depending on the required value for Expression C. The trigger values have to be chosen in such way that the time until either D′ or E′ reaches the trigger value is as long as possible. The triggers on context source proxies D′ and E′ will be adapted when one of the triggers on context source proxies D′ and E′ fires. The threshold triggers are calculated in this example as follows:

$${D}_{thres} = d + \frac{( c - d - e )}{2} ;$$

$${E}_{thres} = e + \frac{( c - d - e )}{2} .$$

In this example, the threshold triggers are calculated as follows:

$${D}_{thres} = 2 + \frac{( 10 - 2 - 3 )}{2} = 4.5 ;$$

$${E}_{thres} = 3 + \frac{( 10 - 2 - 3 )}{2} = 5.5 .$$

When context source proxy E′ fires on value 7 (i.e. generates an event), the trigger thresholds for both context source proxies are adapted as follows:

$${D}_{thres} = 2 + \frac{( 10 - 2 - 7 )}{2} = 2.5 ;$$

$${E}_{thres} = 7 + \frac{( 10 - 2 - 7 )}{2} = 7.5 .$$

When context source proxy D′ fires on value 4, this immediately causes the trigger on Expression C to fire and the event (value=11) that is sent to Expression A will cause Expression A to become true. The triggers are then removed.

The above embodiment example may also use other mathematical functions, as shown in the following multiplication example.

Consider the following expression A: (D*E<10). In this case the trigger values on context source proxies D′ and E′ will be calculated as follows:

$${D}_{thres} = {d}^{*} \sqrt{\frac{10}{{d}^{*} e}} ;$$

$${E}_{thres} = {e}^{*} \sqrt{\frac{10}{{d}^{*} e}} .$$

For every kind of mathematical function, a corresponding setting of trigger thresholds may be made, which will result in as long a time as possible before an event is generated.

In a further scenario it is shown that ranges where additional conditions on values of expressions or context source are given, further optimization is possible. We assume that an expression A exists, which is the sum of B and C. B and C may be context sources or expressions. Furthermore we assume that an additional condition on C exists, that C will be larger than 5. This condition may be the result of some other expression in which C is used, or because of characteristics of the context source C, or because of characteristics and conditions of the context sources and expressions on which C depends. Furthermore we assume that a trigger has been set on A to report as soon as the value of A is larger than 12. We assume that the current value of B is 10 and the current value of C is 6. According to the previously explained method, thresholds for B and C can be calculated. The threshold for B would be 8 and the threshold for C would be 4. However, C already has a condition that it is larger than 5. Therefore the threshold of 4 for C is unnecessary low. The value of C will already be reported as soon as C is smaller than 5, or C cannot become smaller than 5. Therefore the trigger thresholds resulting from the condition on A should not be equally divided between B and C, but C should only have the already given threshold of 5, which leaves a threshold of B of 7 instead of 8, because any combination of thresholds for B and C is valid as long as the sum is equal to the threshold of A. Now B will only send an event when it becomes smaller than 7, which should be later than when it becomes smaller than 8. For C the threshold is still the original threshold of 5, so C will still send an event when C is smaller than 5. So because of this optimization, it will often take more time, but never less time, until an event is sent. This means that using this optimization fewer events will be sent, and therefore the cost will be reduced by this optimization.

From the above examples, it is clear that using ranges will make it possible to set the trigger values on the context source proxies more accurate, which will lead to fewer events.

In a further embodiment a possibility is used to exploit the presence of multiple parent elements sharing a request to child elements (context resources or intermediate expressions). It may be envisaged that the expression C (child expression) of the embodiments and examples above is shared by expression A and another expression X (parent expressions), as shown in FIG. 8. Expression A is the same as in the embodiment of FIGS. 1 and 3, however, the associated context source weights are the different (cost(B)=4, cost(D)=10 and cost(E)=1). When the request for evaluation of expression A and expression X are received at the same time from the respective associated requestors 11, the weight for evaluation of expression C may be shared between the two parent expressions A and X. This may result in a different evaluation result when determining which context source is to be interrogated first: In the situation shown in FIG. 8 it is clear that the context source E has the be interrogated first (indicated by the arrow labeled ‘Request’), as opposed to the situation described above, where context source B was interrogated first.

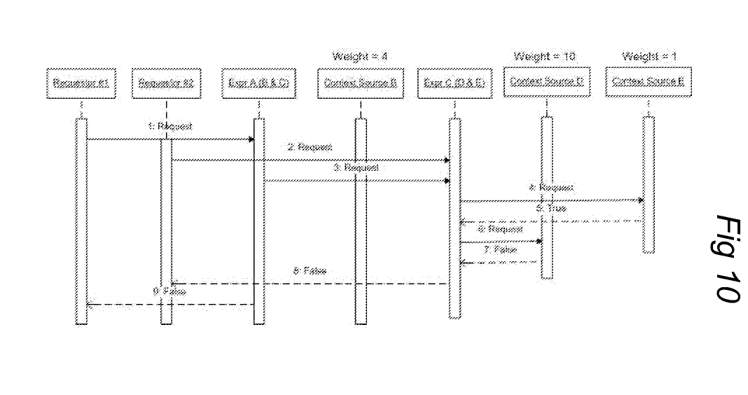

Also with respect to the number of requests, the present invention embodiment of sharing information from the context sources provides a more optimal solution than a naïve solution. In FIGS. 9 and 10, sequence diagrams for the example of FIG. 8 are given, for a least optimal situation, i.e. where context source B and E are true, and context source D is false.

In a naïve version of a lowest weight first implementation, of which the sequence diagram is schematically shown in FIG. 9, the fact that there is more than one parent element (Requestor #1, Requestor #2) seeking the same information is not taken into account. Requestor #1 issues a request to Context source B (sequences 1-3) as this is the lowest weight element of expression A (4 versus 6). Requestor #2 issues a direct request to expression C. This request will be further issued to context sources E and D (first to E as this context resource has the lowest weight of the two elements) in steps 5-9. The result is that expression C evaluates as false, which is reported back to Requestor 2 in step 9. Finally, a request will be made from expression A to expression C again (step 10) as context source B was evaluated as true in expression C. The value of evaluation of expression C is already known (=false), which is propagated back to expression A and eventually Requestor #1.

In an embodiment of the present invention, cost sharing is taken into account. This is illustrated in the sequence diagram of FIG. 10. As it is known that expression C is evaluated for both Requestor #1 and Requestor #2, and the result of evaluation of expression C is false, context source B need not be interrogated anymore. The total number of requests, and consequently the number of result events is in this case lower than in the naïve implementation of FIG. 9.

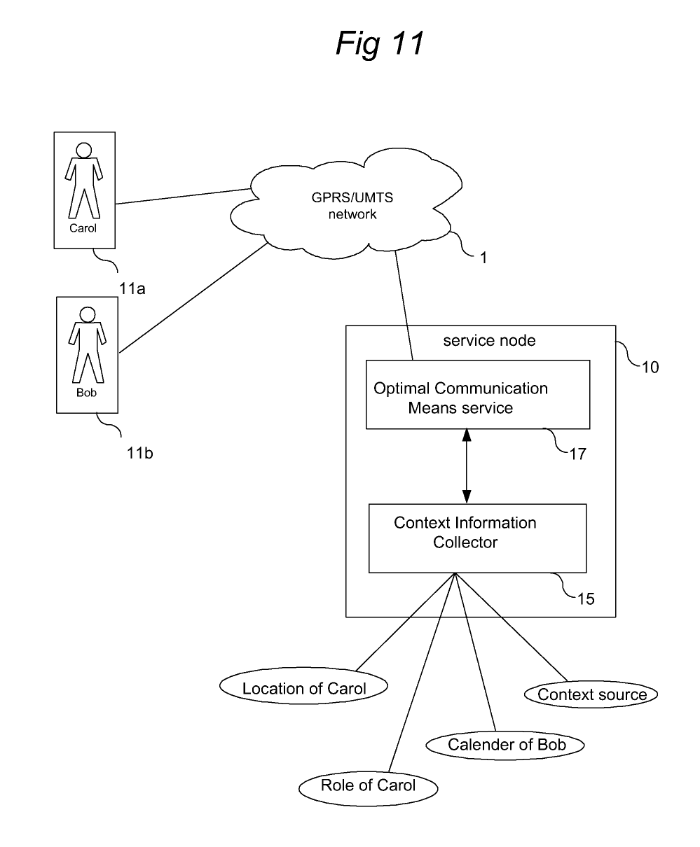

In FIG. 11, a further illustrative example of a possible network architecture is shown for providing a service dependent on the data of more than one context source. In this example, there are two requestors 11a (Carol) and 11b (Bob), which are connected to a GPRS/UMTS network 1. The GPRS/UMTS network 1 is connected to a service node 10, which is arranged to provide an Optimal Communication Means (OCM) service, e.g. implemented as an application 17 in the service node 10. The service node 10 further comprises a Context Information Collector (CIC) 15, which is arranged to interface with a number of context sources.

Carol and Bob are subscribed to the ‘Optimal Communication Means Service’ and have defined a profile with the preferences they have upon optimal communication means in specific situations. These preferences are stored by the OCM service 17, e.g. in a database (not shown). This means that the profile of Bob is used to decide upon the list of communication means presented to Carol when he/she tries to communicate with Bob.

Carol is in her car and is trying to reach Bob who is at work in a meeting. Bob has defined in his profile that he can be reached by Instant Messaging, SMS or voice mail while in a meeting. Carol has defined in her profile that she can only use voice communication while driving a car. Carol selects Bob from the contact list. The OCM service 17 retrieves the applicable context from both Carol and Bob through the CIC 15. The OCM service 17 discovers that because of the context of Carol and Bob there is no communication means available at this very moment and presents this through a voice message to Carol (via GPRS/UMTS network 1). The OCM service 17 also gives Carol the choice of contacting her as soon as Bob becomes available. Carol decides that she wants to contact Bob through a voice call as soon as Bob becomes available.

As soon as Bob's meeting has ended his context changes in such a way that he is reachable through voice. The OCM service 17 decides to contact Carol and Carol can decide to call Bob. The following context sources are applicable in this scenario:

Calendar info (Bob): To determine in-meeting for instance;
Role (Carol): To determine in-car situation;
Location (Carol): To determine speed.

The various method embodiments may also be used in this example, i.e. to determine which context source is to be interrogated first based on the cost of evaluating the expression used by the OCM service 17.

The expression and intermediate expressions as used in the above embodiments and descriptions are functions of boolean elements, having a value of either true or false. In further embodiments, the elements may also comprise functions of numerical values obtained from context sources B, D, E, e.g. to check whether a value of a context source is within a certain range. In actual network implementations, some of the context sources may respond with a value ‘unknown’ when a value is not available, e.g. in case a cell phone is turned off, or a GPS system does not deliver any information. In most applications this will result in an exception code, which may lead to unavailability of the service.

In a further embodiment, this possibility of a context source providing a value of unknown may be utilized to further improve the efficiency of the network or to reduce cost. In a first variant, it is taken into account that next to the boolean values true and false, a context source B, D, E, may provide the value unknown as response to an interrogation. Depending on the (intermediate) expression to be evaluated, this may result in the finding that it is not necessary to interrogate any further context sources for that request, thus reducing network data traffic and interrogation cost.

In a first example, again the expressions A and C of FIG. 1 is used: intermediate expression C is true when both context sources D and E return a value true, and expression A is true when both context source B and intermediate expression C return a value true. Suppose that context source E is unavailable, then the value of intermediate expression C depends on the value of context source D. After all, when context source D returns false, intermediate expression C will evaluate to false as well, but if the value of context source D is true or unknown, the value of intermediate expression C is unknown. If the value of intermediate expression C is false, there is no need to continue asking for context source B's or E's values, which saves network resources. If the value of intermediate expression C is unknown, context source B must be interrogated.

The following table summarizes this as follows

| | | | |
|---|---|---|---|
| and | E = true | E = false | E = unknown |
| D = true | C = true | C = false | C = unknown |
| D = false | C = false | C = false | C = false |
| D = unknown | C = unknown | C = false | C = unknown |

The false cases in the unknown row and column (=bold face) are caught automatically through this invention, which is an extra optimization not taken care of before.

In the next example, the result of this embodiment will be viewed in case of a boolean OR expression. Suppose that both expression A and expression C are boolean or-expressions which return true when at least one of the context sources or child expressions is true, then the same logic applies. When context source D is unknown, then the service should still ask context source E for its value. Suppose that context source E is true, then it does not matter that context source D is unknown. After all, when one of the context sources is true, expression C results in true as well. Then, the condition to have expression C return true is satisfied, and no more network resources need to be wasted. The following table gives an overview of the return values (the case explained above can be mapped on the bold entries):

| | | | |
|---|---|---|---|
| or | E = true | E = false | E = unknown |
| D = true | C = true | C = true | C = true |
| D = false | C = true | C = false | C = unknown |
| D = unknown | C = true | C = unknown | C = unknown |

The true cases in the unknown row and column (=bold face) are caught automatically through this invention, which is an extra optimization not taken care of before.

In a further variant, the context source B, D, E, is first interrogated on availability of the respective value. Only when the context source does not return unknown will it be asked for its value, in the case of booleans, true or false, or in the case of integer range values, the value itself.

If the context source B, D, E, does return unknown, the latest value retained from a previous request can be used as input for the expression A or C.

In an example of this embodiment, for boolean values, each expression and context source contains two options, Availability and Latest. Availability consists of two choices, available and true, or available and false. When the context source value is unknown, the service can look at the latest value retained (Latest), which can also be either true or false. In this way, unknown values are no longer an issue. Unknown values are represented by the two cases in which the Availability is false. The Availability depends on the Latest and Availability values of the children elements (either expressions or context sources). Suppose expression C=A & B. Then the Availability of expression C depends on the Latest and Availability of elements A and B as follows:

Availability(C)=(Availability(A) & Availability(B))

|(Availability(A) & not Latest(A)))

|(Availability(B) & not Latest(B)))

In words, expression C is known, if elements A and B are known (in which case the value of expression C is the value of the boolean AND (A & B), or if element A is available and false (in which case the value of expression C is false) or if element B is available and false (in which case the value of expression C is false).

Initially the Latest value can be set to either true or false. As soon as the context source or expression becomes known, the correct value will be set. As long as the Availability is false, the value of Latest should not be used.

The above described embodiments and examples are not meant to limit the scope of protection of the present application, which is defined by the features as described in the appended claims.

1. A method for providing a service in a communication network, in which the service comprises evaluating a request comprising an expression, the expression being a function of a plurality of elements, each element relating to data originating from one or more context sources available in the communication network, or relating to an intermediate expression, in which each one of the one or more context sources updates its associated data using a request based mechanism or an event trigger based mechanism, the method comprising:
interrogating a selected one of the plurality of elements,
if the expression evaluates to a first value based on the received value of the selected element, then switching the selected element to a trigger mode, and
if the expression evaluates to a second value based on the received value of the selected element, then proceeding with interrogating a further one of the plurality of elements.

2. The method according to claim 1, the method further comprising
determining an order of context sources based on the expression and weights of the context sources a weight of a context source being a function of network resources used and a monetary value for evaluation of the expression towards the one or more context sources and in which the selected element is the lowest order context source, and the further one of the plurality of elements is the next lowest order context source.

3. The method according to claim 1, in which the expression is a boolean function, the data from each of the context sources being true or false.

4. The method according to claim 1, in which the data from the context sources is a numeric value, and the expression comprises a function of the values of the context sources.

5. The method according to claim 4, in which the function comprises a comparison of the numeric value with a predetermined range.

6. The method according to claim 5, in which the function comprises an evaluation of a mathematic operation of the values of one or more of the context sources.

7. The method according to claim 5, in which the evaluation of a mathematical operation involving data values from two or more context sources comprises setting a trigger threshold for each of the context sources depending on the actual values and the mathematical operation.

8. The method according to claim 3, in which the value of the data from each of the context sources is unknown.

9. The method according to claim 8, in which the method further comprises using a latest obtained value for the respective context source value if the value is unknown.

10. The method according to claim 1, in which the data of each the plurality of context sources is stored in an associated proxy server accessible for the service

11. The method according to claim 1 further comprising using a child expression by multiple parent expressions, and the weight for evaluating the child expression is shared between the multiple parent expressions when the associated requests are received simultaneously.

12. Service node for a communication network providing a service in the communication network, in which the service node is arranged to receive and evaluate a request, the request comprising an expression being a function of a plurality of elements, each element relating to data originating from one or more context sources the service node, in operation, being connectable to the one or more context sources, in which the service node is further arranged for:
interrogating a selected one of the plurality of elements,
if the expression evaluates to a first value based on the received value of the selected element, then switching the selected element to a trigger mode, and
if the expression evaluates to a second value based on the received value of the selected element, then proceeding with interrogating a further one of the plurality of elements.

13. The service node according to claim 12, in which the service node comprises a rule interpreter for evaluating the expression.

14. The service vise node according to claim 12, in which the service node comprises a context information collector for interfacing with the one or more context sources.

15. The service node according to claim 14, in which the context information collector 15) comprises a context source proxy for each of the one or more context sources, for storing data associated with each respective context source.

16. The service node of claim 12, further comprising:
means for determining an order of context sources based on the expression and weights of the context sources a weight of a context source being a function of network resources used and a monetary value for evaluation of the expression towards the one or more context sources, and
in which the selected element is the lowest order context source, and the further one of the plurality of elements is the next lowest order context source.

17. The service node of claim 12, in which the expression is a boolean function, the data from each of the context sources being true or false.

18. The service node of claim 12, in which the data from the context sources is a numeric value, and the expression comprises a function of the values of the context sources.

19. The service node of claim 18, in which the function comprises a comparison of the numeric value with a predetermined range.

20. The service node of claim 19, in which the function comprises an evaluation of a mathematic operation of the values of one or more of the context sources.

21. The service node of claim 19, in which the evaluation of a mathematical operation involving data values from two or more context sources comprises setting a trigger threshold for each of the context sources depending on the actual values and the mathematical operation.

22. The service node of claim 17, in which the value of the data from each of the context sources is unknown.

23. The service node of claim 22, further comprising means for using a latest obtained value for the respective context source value if the value is unknown.

24. The service node of claim 12, in which the data of each the plurality of context sources is stored in an associated proxy server accessible for the service
